(19) United States
(12) Patent Application Publication
(10) Pub. No.: US 2007/0056332 A1
(43) Pub. Date: Mar. 15, 2007

(54) Rigid handcuff

(75) Inventors: Kevin L. Parsons, Appleton, WI (US); Lestor O. Stener, Blaine, MN (US)

Correspondence Address: Richard L. Wood;22nd Floor, 120 South Riverside Plaza, Chicago, IL, 60606-3945, US

(73) Assignee: Armament Systems & Procedures, Inc., Appleton, WI (US)

(21) Appl. No.: 11/223,629

(22) Filed: Sep. 9, 2005

(51) Int. Cl. E05B 75/00

(52) U.S. Cl. 70/16

(57) ABSTRACT

A rigid handcuff assembly is disclosed that includes a pair of handcuff bracelets adapted to be releasably applied to a person's wrists. The handcuff bracelets include cheek plate assemblies that are pivotally interconnected to a connecting block that includes locking mechanism enabling movement of the handcuff bracelets between folded positions disposed in overlying juxtaposed relation, and positions wherein the handcuffs are automatically locked in rigid substantially coplanar aligned relation. The interconnected cheek plate assemblies define a handgrip when disposed in rigid aligned relation. The handgrip has structural indicia thereon adapted to be sensed by the user's hand, such as a raised palm swell surface sensed by the palm of a user's hand, and thumb sensing indicia disposed in predetermined relation to the user's thumb when gripping the handcuff, thereby enabling predetermined orientation and manipulation of the rigid handcuffs without direct eye contact with the handcuff assembly. The handgrip includes shield surfaces that shield fingers, the web and base of the user's hand when gripping the handgrip.

### FIELD OF THE INVENTION

The present invention relates generally to handcuffs, and more particularly to a rigid handcuff that includes a pair of bracelet type lockable handcuffs adapted to be releasably placed about a subject's wrist and which are hingedly interconnected to enable the handcuffs to be secured in a rigid generally planar aligned relation and griped intermediate the handcuffs for ease of manipulation and orientation during stressful conditions, and which can be foldable into compact overlying relation for carrying on one's person for ready access.

### BACKGROUND OF THE INVENTION

Handcuffs are well known for use by law enforcement, military and security personnel. Traditional handcuffs employ a pair of bracelet type handcuffs that are interconnected by a flexible link type connector chain and have pivotal bows or clasp members adapted to be placed about a subject or detainee's wrists and releasably locked so as to impede movements of the subject's arms. Such handcuffs require that a bracelet type handcuff be applied to one wrist of a suspect or detainee while the other handcuff is retained in the enforcement officer's hand or allowed to dangle from the handcuff being applied. The second connected handcuff must then be grasped and applied to the detainee's other wrist, all of which requires specific attention to detail in manipulating the second handcuff with the result that the enforcement officer's attention is at least partially diverted from the detainee. This can result in placing the officer in a potentially dangerous situation.

The aforedescribed drawback in the use of flexibly interconnected pairs of handcuffs has been overcome for the most part by what are generally termed rigid handcuffs. One example of rigid handcuffs is disclosed in U.S. Pat. No. 4,840,048 wherein a pair of conventional bracelet type handcuffs are interconnected by a flexible connector chain. Each handcuff includes a crescent shaped base having a generally C-shaped bow or clasp member pivotally supported thereon, and defines a main support section that houses a key operated lock assembly operative to releasably lock the bow or clasp in locked relation about a detainee's wrist. A rigid handcuff restraining assembly in the form of a pair of rigid plates or half-sections are sandwiched about the connector chain and portions of the handcuff lock assembly support sections so as to form a rigid interconnection of the spaced handcuffs. The rigid plates maintain the handcuffs in spaced aligned relation and define a handgrip enabling an arresting officer to grasp the handgrip portion and manipulate the rigid handcuff assembly in a manner to apply one handcuff to a detainee's wrist and manipulate the rigid assembly in a manner to subdue any threatening moves of the detainee, after which the free handcuff can be applied to the detainee's other wrist. This type of rigid handcuff can be defined as a non-foldable rigid handcuff.

A significant shortcoming with rigid handcuffs of the type disclosed in U.S. Pat. No. 4,840,048 is that they are too large and cumbersome to be carried with other equipment that a police officer needs to carry on his/her duty belt. Such rigid handcuffs are also too large and cumbersome to be conveniently carried under a suit coat by detectives so as to be readily accessible but not create an identifiable bulge.

Another rigid type handcuff design utilizes a pair of handcuffs that are hingedly interconnected through a lockable connecting member in a manner to enable the handcuffs to be retained in rigid aligned relation, or pivoted about hinge axes so as to lie in compact overlying juxtaposed relation to each other. An example of such a rigid hinged type handcuff is disclosed in U.S. Pat. No. 5,687,593 and can be defined as a foldable rigid handcuff.

A significant drawback with the hinged handcuffs disclosed in U.S. Pat. No. 5,687,593 occurs when the hinged handcuffs are in overlying juxtaposed relation to each other, termed the closed position, as when carried on an officer's belt or the like, and the officer needs to quickly grasp the overlying handcuffs and pivot one of the handcuffs into locked aligned relation with the other, termed the open position, and grasp the rigid aligned handcuffs in proper orientation for applying the bow or clasp member of one of the handcuffs to a detainee's wrist. This requires that the officer at least momentarily turn his/her visual attention to checking the rigid handcuff to insure the proper orientation for application of a handcuff to the detainee's wrist. This visual distraction from the detainee can often create an endangerment to the officer.

Another drawback in the commercial rigid handcuff that carries the U.S. serial number corresponding to U.S. Pat. No. 5,687,593 occurs when the officer wishes to return the handcuffs from open locked rigid aligned positions to closed compact overlying juxtaposed positions. This requires that the officer hold one of the handcuffs in one of the officer's hands in generally vertical relation, such as the left hand of a right-handed person, and insert a key held in the officer's right hand into a keyway within the connecting member so as to release the lock catch member and enable gravity pivotal movement of the upper handcuff to its overlying juxtaposed relation to the handcuff held in the officer's left hand. In the aforenoted commercial rigid handcuff, the released upper handcuff can only pivot in the direction of the inserted key, thus creating the real possibility that the relatively heavy uppermost handcuff will impact the officer's key-holding thumb and fingers before the key is retracted from the keyway.

A further drawback in the commercial embodiment of the rigid handcuff bearing the serial number of U.S. Pat. No. 5,687,593 lies in the fact that each of the pivotally connected bracelet type handcuff members is capable of being locked in coplanar relation with the connecting member while the other handcuff member remains in its folded or closed position relative to the connecting member. This can result in the folded handcuff being disposed at a right angle to the locked handcuff member. This is particularly troublesome if a law enforcement officer, such as an undercover officer or detective in street clothes, carries the folded handcuff over a belt under a suit coat or jacket and the outer hanging handcuff member is inadvertently raised to a position causing the inner handcuff to be locked in coplanar relation with the connecting member, thereby causing the outer handcuff member to extend outwardly at a substantially right angle to the locked handcuff member and create a noticeable give-away identifying bulge in the officer's clothing.

The rigid handcuffs disclosed in both U.S. Pat. Nos. 4,840,048 and 5,687,593 exhibit additional drawbacks. Firstly, the '048 patent handcuff employs a main handle assembly constructed of half sections that may be made of rigid plastic or a carved wood. As such, what is termed the “right handle member 54” has generally oval shaped keyhole openings formed therein spaced so as to be positioned above the respective lock openings (keyways) on the lock assemblies of each handcuff bracelet member when the half sections secured together. The connecting member of the handcuff disclosed in the '593 patent comprises a number of laminated metal plates, the outermost ones of which have plastic covers formed thereon to provide a more comfortable grip. By making the handle assembly of half sections that are sandwiched about the lock assemblies, as disclosed in the '048 patent, or providing plastic covers over outer metal laminations, as disclosed in the '593 patent, mis-alignment between the keyhole openings in the plastic handle sections or in the plastic cover layer formed on a metallic plate and the keyways formed in the underlying lock assemblies can readily occur and inhibit key insertion and release of a locked bow or clasp member. Moreover, oval or circular openings formed in the plastic covers require the user to manually orient the key so that it will enter the underlying keyway for cooperation with the associated lock mechanism. This can be time consuming and a visual distraction from the person on whose wrist the handcuff is to be applied or from whom the rigid handcuff is being removed.

A further drawback with the rigid handcuffs disclosed in U.S. Pat. Nos. 4,840,048 and 5,687,593 lies in providing a handgrip area for grasping by the user's hand that does not prevent the web of the user's hand from inadvertent contact with the handcuff bow as it rotates around during application to a detainee's wrist, thus resulting in potential injury to the hand. The handgrip area of these prior handcuffs also allows the user's fingers to get in the way of the swinging or rotating bow to thereby prevent proper movement of the bow and/or causing injury to the user's fingers.

Another drawback with the rigid handcuff disclosed in U.S. Pat. No. 5,687,593 and found in the aforenoted corresponding commercial rigid handcuff lies in the use of a catch member that is movable within the connecting member and has formations that are caused to extend into and engage recesses in the bracelet member body parts in order to retain the bracelet members in extended aligned positions. This requires that both the catch member and the bracelet member body parts be made of high strength materials to withstand bending and/or fracture should a detainee subject a bracelet member to a high impact force while mounted on the detainee's wrist, such as by slamming an edge of a bracelet member against a fixed object in an attempt to open the handcuff bow. This design thus leads to higher costs for suitable strength catch member and bracelet body part materials, higher machining costs to create recesses in the bracelet body parts, and the inability to economically repair a damaged catch member or bracelet body part.

There thus exists a need for a high strength economical rigid handcuff of the type employing a pair of bracelet type handcuffs that are hingedly connected to a common hinge or connecting block having a lock assembly therein operative to automatically lock the hinged handcuffs in rigid aligned coplanar relation only when the handcuffs are disposed in such aligned relation, wherein the aligned handcuffs define a handgrip having a plastic overmold that insures ready key access to keyways in the handcuff lock assemblies and is configured to prevent the fingers and web of a user's hand from contact with the handcuff bows during rotation of the bows as they are applied to a person's wrist, and wherein the rigid handcuffs and connecting block define physical sensing indicia that enable correct orientation of the rigid handcuff in either of the officer's hands and manipulation of the bracelet type handcuffs without need for distracting direct visual observation of the handcuffs, the rigid open aligned handcuffs being releasable in response to insertion and minimal rotation of a key into the connecting block keyway to enable re-positioning of the handcuffs into compact closed juxtaposed positions without impacting the officer's fingers, thus overcoming the aforedescribed shortcomings in prior rigid handcuffs.

### SUMMARY OF THE INVENTION

In accordance with a presently preferred embodiment of the present invention, a rigid handcuff is provided which includes a pair of bracelet type handcuffs that are interconnected to enable pivotal movement between a position wherein the handcuffs are releasably retained in rigidly aligned substantially coplanar relation, termed the open position, and a position wherein the handcuffs are disposed in overlying juxtaposed relation, termed the closed position, for carrying on one's person. Each of the handcuffs includes a cheek plate assembly that includes a die stamped stainless steel cheek plate frame and pivotally supports an arcuately shaped bow for application to a detainee's wrist. The bow has ratchet teeth thereon cooperative with ratchet teeth on a locking pawl of a lockset supported within a base of the cheek plate assembly to lock the bow in a position wherein the bow can be moved inwardly about its pivot axis relative to the cheek plate assembly, but cannot be moved in a reverse direction without insertion of a key to release the locking pawl. A lightweight locking bar is also carried by the lockset and is movable from a position enabling release of the locking pawl to a position preventing release of the locking pawl, thereby establishing a double lock for the locking pawl.

The base for each cheek plate assembly is pivotally or hingedly connected to a connecting block through a separate pivot shaft carried by the connecting block and having discrete length segments of polygonal transverse cross section. A locking member is slidably supported within the connecting block and is biased to a position cooperative with the polygonal length segments of the pivot shafts to automatically lock the pivot shafts, and thereby also the bracelet type handcuffs, in rigid open positions only when the handcuffs are disposed in aligned substantially coplanar relation. A keyway is provided in the connecting block to enable entry of a key for releasing the locking member from locking relation with the pivot shafts upon relatively minor rotation of the key. The handcuffs cooperate with the connecting block to limit pivotal movement of the handcuffs only in a direction opposite the keyway side of the connecting block to overlying juxtaposed positions. The metallic cheek plate assemblies have a polymer overmold formed thereon so that the connected cheek plate bases define a comfortable handgrip. Indicia in the form of a raised palm swell is formed on a selected side of the handgrip and can be physically sensed by the palm of the user's hand when gripping the handgrip with the handcuff in a predetermined orientation. Additional indicia in the form of a raised generally semi-spherical projection and a depressed recess are formed on the side surface of the handgrip opposite the raised palm swell side for physical sensing, respectively, by the user's right and left hand thumbs to sense that the handcuff is in an orientation wherein the bow is facing outwardly from the hand gripping the handgrip for application to a person's wrist when the raised palm swell is sensed by the palm of the hand. The handgrip is also configured to shield the pointing finger and little finger of the hand gripping the handgrip, and also shield the web and base of the user's gripping hand from getting in the way of the handcuff bows as the bows swing around during application to a person's wrist.

Accordingly, one of the primary objects of the present invention is to provide a rigid handcuff assembly that includes a pair of aligned substantially coplanar bracelet type handcuffs defining a handgrip for grasping by a user's hand and having structural indicia thereon enabling physical sensing by the palm and thumb of a user's hand when gripping the handgrip so as to facilitate predetermined orientation and manipulation of the rigid handcuff without specific eye contact with the handcuff assembly.

Another object of the present invention is to provide a rigid handcuff assembly as aforedescribed wherein the bracelet type handcuffs are hingedly interconnected to enable movement between rigid aligned substantially coplanar positions, termed open positions, and folded compact overlying juxtaposed positions, termed closed positions, the physical indicia on the handgrip enabling physical sensing of the orientation of the handcuff by the palm and thumb of the user's hand when gripping the handgrip with the handcuffs in their open aligned positions.

Another object of the present invention is to provide a rigid handcuff assembly as aforedescribed wherein the structural indicia enabling physical sensing by a user's gripping hand includes a raised palm swell formed on a predetermined side of the handgrip and adapted to be physically sensed by the palm of the user's gripping hand when the handcuffs are in rigid open aligned positions, and physical indicia adapted to be sensed by the user's thumb to indicate proper orientation of the rigid handcuff when gripping the handcuff in either the user's right or left hand.

A further object of the present invention is to provide a rigid handcuff assembly that includes a pair of bracelet type handcuffs hingedly interconnected to a connecting block through pivot shafts affixed to the bracelet type handcuffs, and wherein the connecting block includes a locking member operative to receive and mate with polygonal cross-sectional length segments of the pivot shafts to automatically lock the handcuffs in rigid open aligned positions only when both of the handcuffs are pivoted from closed generally juxtaposed positions to open fully aligned substantially coplanar positions. An ancillary feature of the connecting block is that it is incapable of locking one of the bracelet handcuffs in an open position when the other handcuff is not also in an aligned open position.

A feature of the rigid handcuff assembly of the present invention lies in providing a locking member in the connecting block that receives and mates with discrete length polygonal cross-section segments of the pivot shafts in sliding relation therewith and is spring biased to a locking position with the pivot shafts when the handcuffs are in open aligned substantially coplanar relation, but can be released from such locking position in response to relatively minimal rotation of a key inserted into the connecting block for cooperation with the locking member. The pivot shafts are preferably of high strength heat treated steel and their polygonal cross-sectional segments provide a mechanical advantage over known prior rigid handcuffs.

Another feature of the handcuff assembly of the present invention lies in hingedly connecting the bracelet type handcuffs through a connecting block as aforedescribed so that the handcuffs pivot in a direction away from a keyway provided in the connecting block and thereby prevent a handcuff from impacting the user's fingers when manipulating a key inserted into the connecting block keyway to release the handcuffs from their rigid aligned positions.

Another feature of the rigid handcuff assembly in accordance with the present invention lies in providing a plastic injection overmold to the metallic cheek plate. assemblies so that the various keyway openings formed in the metallic cheek plate assemblies are not impeded by the plastic overmold and orientation of a key as it enters into the cheek plate keyway is assisted by the keyway shaped opening in the overmold.

A further feature of the rigid handcuff assembly of the present invention lies in the handcuffs being configured to define a handgrip for grasping by a user's hand when the handcuffs are disposed in rigid aligned relation, the handgrip being configured to define shields for shielding the pointing finger and little finger of the user's hand, and also shielding the web and base of the user's hand from getting in the way of the handcuff bow as it swings about its pivot axis when applied to a person's wrist, thereby preventing interference with the bow movement and possible injury to the user's hand.

Another feature of the rigid handcuff in accordance with the present invention lies in the provision of non-metallic hinge members that are adapted to fit within the die-stamped cheek plate base frame portions and establish contact and stop surfaces for cooperation with a mold to limit flow and establish boundaries for a polymer when injected into the mold to create a polymer overmold on the cheek plate assembly and associated base frame.

Still another feature of the rigid handcuff in accordance with the present invention lies in making the cheek plate assemblies with die stamped stainless steel cheek plate frames that resist attempts by a detainee to bend the cheek arms which pivotally support the handcuff bow so as to enable access to the bow for prying the bow from its locked relation about the detainee's wrist.

Further objects, features and advantages of the rigid handcuff in accordance with the present invention will become apparent from the following detailed description taken with the accompanying drawings wherein like reference numbers designate like elements throughout the several views.

While the present invention is susceptible of various modifications and alternative forms, a specific embodiment thereof is shown by way of example in the drawings and will herein be described in detail. It should be understood, however, that the drawings and detailed description thereof are not intended to limit the invention to the particular form disclosed, but on the contrary, the invention is intended to cover all modifications, equivalents and alternatives falling within the spirit and scope of the invention. For example, many of the features of the rigid handcuff in accordance with the illustrated embodiment find application with rigid handcuffs that are not capable of folding the bracelet type handcuffs between open aligned positions and folded closed overlying positions.

### BRIEF DESCRIPTION OF THE DRAWINGS

FIG. 1 is a plan view of a rigid handcuff assembly constructed in accordance with the present invention showing a pair of handcuffs pivotally interconnected to a connecting block and locked in rigid aligned coplanar relation partially;

FIG. 2 is a plan view showing the opposite side of the rigid handcuff shown in FIG. 2;

FIG. 3 is an edge view taken substantially along line 3-3 of FIG. 1;

FIG. 4 is a plan view showing the rigid handcuff of FIG. 1 released from its rigid condition with the handcuffs being pivotally folded toward a overlying juxtaposed relation;

FIG. 5 is a perspective view illustrating the handcuffs in their folded juxtaposed relation;

FIG. 6 is an exploded perspective view illustrating various components of the rigid handcuff but with the handcuff bow removed and prior to applying a plastic coating or overmold to the various components;

FIG. 7 is a bottom view of the locking member and pivot shafts employed in the connector block illustrated in FIG. 6, portions of the locking member being broken away for clarity;

FIG. 8 is a perspective view looking at the bottom of locking member shown in FIGS. 6 and 7;

FIG. 9 is a sectional view taken along 9-9 of FIG. 8;

FIG. 10 is a fragmentary perspective view illustrating the relationship of the locking ember, pivot shafts and handcuff base frames with a key inserted into the locking member to effect movement thereof from a position locking the handcuffs in aligned planar relation to a position enabling pivotal movement of the handcuffs relative to each other, the lower cover of the connecting block being removed for clarity; and

FIG. 11 is a plan view of a key for releasing the handcuff bows from locked closed positions and for releasing the locking mechanism within the connector block that maintains the handcuffs in rigid aligned relation.

### DETAILED DESCRIPTION OF THE INVENTION

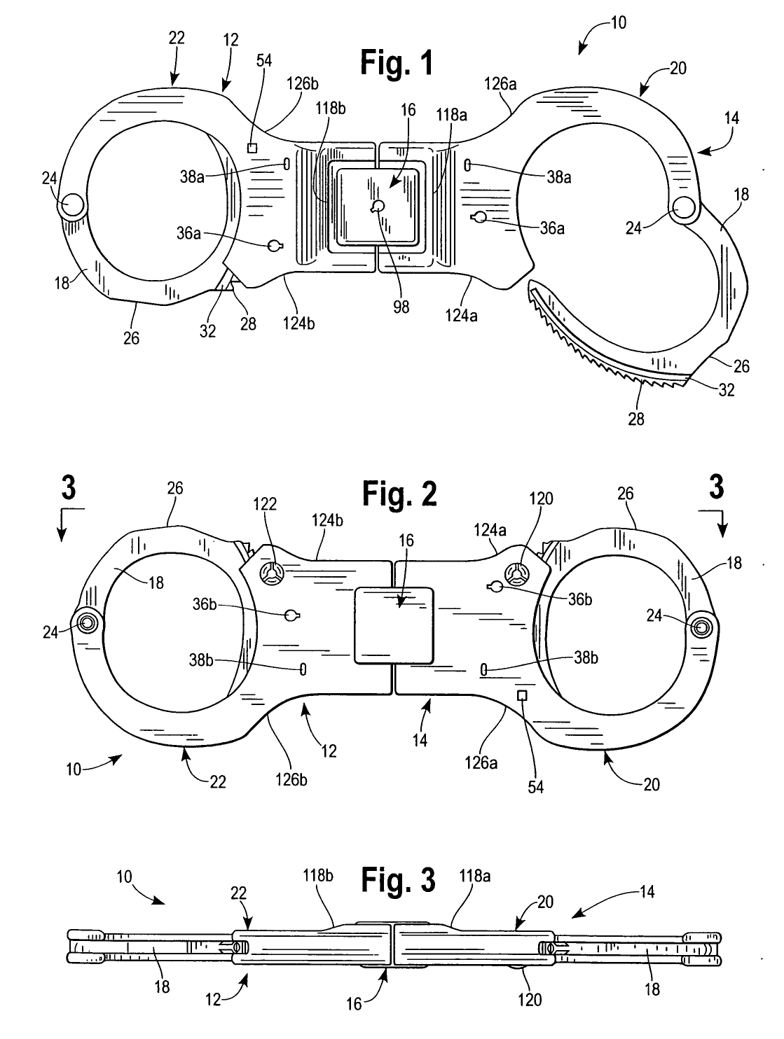

Referring now to drawings, and in particular to FIGS. 1-5, a rigid handcuff constructed in accordance with a presently preferred embodiment of the invention is indicated generally at 10. The rigid handcuff 10, which may be termed a handcuff assembly, includes a pair of bracelet type handcuffs 12 and 14 that are mirror images of each other and are pivotally or hingedly interconnected to each other through a connecting block indicated generally at 16. Very generally, the handcuffs 12 and 14 are adapted to be releasably locked in rigid aligned substantially coplanar relation, termed open positions as illustrated in FIGS. 1-3, but can be pivotally folded about pivot axes defined by the connecting block to positions wherein the handcuffs are in overlying substantially juxtaposed relation, termed closed positions as illustrated in FIG. 5.

Each of the handcuffs 12 and 14 includes an arcuately shaped bow 18 that is pivotally connected to a cheek plate assembly 20 that may be made from a suitable metal stamping having a plastic overmold thereon. Each bow is rotatable or swingable about a pivot connection 24 to the cheek plate assembly 20 between an open position, as illustrated on handcuff 14 in FIG. 1, and a closed locked position with the cheek plate assembly 20, as illustrated on handcuff 12 in FIG. 1, in a manner to enable the bow to be placed about a person's wrist and cooperate with the cheek plate assembly to releasably lock the handcuff on the person's wrist as is known. The bows 18 are preferably made from stainless steel powder which is sintered under pressure in a mold and heated to a suitable sintering heat. The bows are formed with rounded margined edges so as to minimize trauma to the wrist of a person being restrained, and have outer generally flat surface areas 26 designed to be applied against the person's wrist for pushing the corresponding bow 18 through the cheek plate assembly to come full circle about the bows pivotal connection 24 and cooperate with the cheek plate assembly to encircle the person's wrist.

Each of the bows 18 further has a plurality of uniformly spaced inclined ratchet teeth, such as indicated at 28 in FIG. 1, formed on a portion of its outer arcuate surface for mating relation with similar but reversely inclined ratchet teeth formed on a locking pawl of a replaceable lockset (not shown) releasably retained within its corresponding cheek plate assembly 20 or 22. The lockset assembly and its operative association with the ratchet teeth on the associated bow are disclosed in greater detail in pending U.S. patent application Ser. No. 10/854,754 owned by the assignee of the present invention and incorporated herein by reference. Each of the bows 18 further has a pair of oppositely outwardly facing arcuate grooves, one of which is indicated at 32 in FIG. 1, that serve as track grooves adjacent the bow ratchet teeth and cooperate with track guide detents (not shown) supported adjacent the bow entry area of the cheek plate assembly to provide guide rails received within the track grooves in the bows.

As disclosed in pending application Ser. No. 10/854,754, the replaceable lockset assembly supported internally of each of the cheek plate assemblies 20 and 22 includes a locking pawl (not shown) that is spring biased to a position wherein inclined ratchet teeth on the locking pawl allow the inclined ratchet teeth 28 on the bow to move over the ratchet teeth on the lockset pawl when the bow 18 is moved into the cheek plates through a 360° arc about its pivot axis 24 but prevent movement of the bow in a reverse direction. This action serves to lock the bow in a closed position about a person's wrist when the ratchet teeth 28 are wholly or partially disposed within the associated cheek plate assembly as illustrated in FIG. 2. Each lockset assembly also includes a locking bar (not shown) that can be moved longitudinally laterally by inserting a suitable cylindrical shaft, such as indicated at 37a on the key 37 shown in FIG. 11, into either of two elongated slots 38a and 38b opening outwardly of opposite sides of the corresponding cheek plate assembly 20 or 22. The locking bar can be moved by the shaft 37a to a position wherein the locking bar prevents movement of the locking pawl from its locking relation with the bow, thereby providing a double lock preventing movement of the corresponding bow in either rotational position about its pivot axis 24. A spring biased detent releasably maintains the locking bar in its locking position until moved to a second unlocking position in response to insertion and rotation of a key, such as illustrated in FIG. 11, into either of two keyways 36a and 36b provided in opposite sides of the cheek plate assemblies. As disclosed in application Ser. No. 10/854,754, release of the locking bar from its double lock position enables the locking pawl to be released from its locking relation with the bow 18 in response to further rotation of the key 37, thereby enabling the bow to be released from a person's wrist.

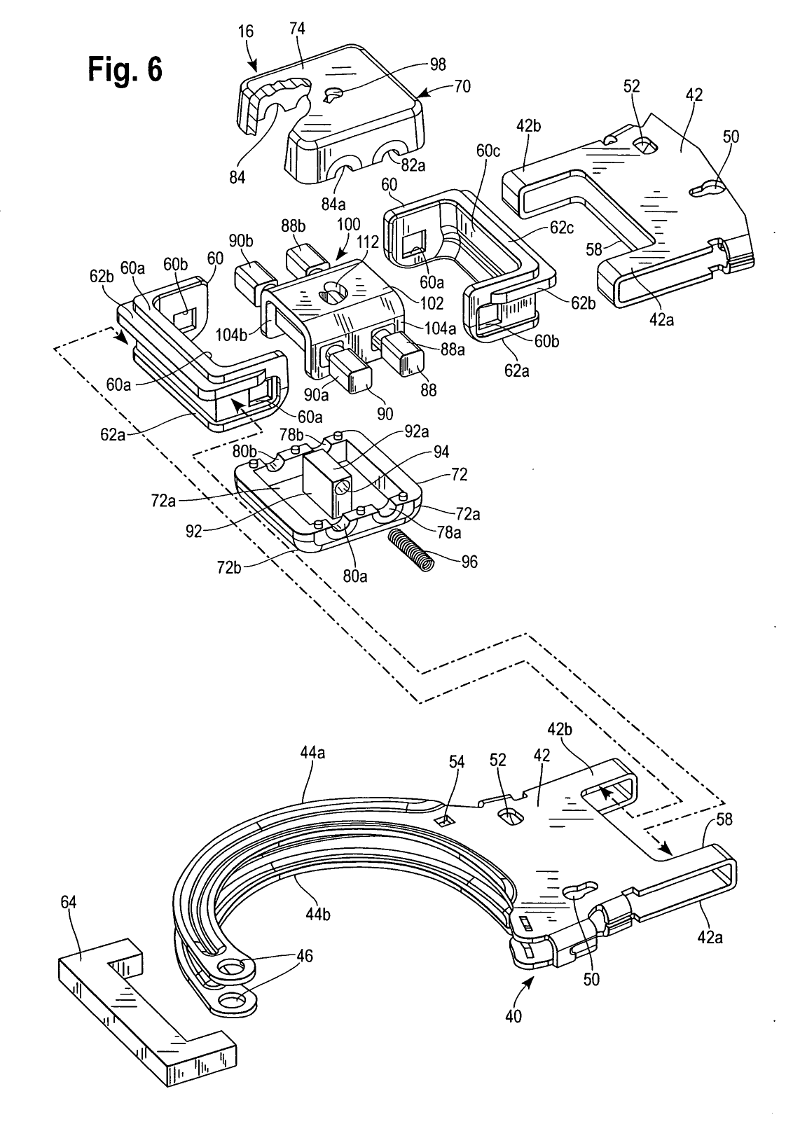

As aforedescribed, the handcuffs 12 and 14 are pivotally or hingedly connected to each other through the connecting block 16 so as to enable pivotal movement of the handcuffs between a position wherein the handcuffs are locked in rigid open aligned substantially planar relation, as illustrated in FIG. 1, or folded to pivotal closed positions wherein the handcuffs are disposed in substantially overlying juxtaposed relation as illustrated in FIG. 5. The cheek plate assemblies 20 and 22 illustrated in FIGS. 1-5 have a plastic overmold formed on a die stamped stainless steel metallic cheek plate frame, such as indicated generally at 40 in FIG. 6, that includes a base frame 42 and arcuate shaped cheek arms or cheek arm plates 44a and 44b that are disposed in parallel relation and pivotally support the bows 18.

The base frame portion 42 of each cheek plate frame 40 is adapted to releasably receive a replaceable lockset having a locking pawl and associated lock bar. The base frame portion 42 has a pair of keyways 50 formed in opposite sides that are laterally spaced and positioned for alignment with keyways formed in the lockset assembly when mounted within the corresponding base frame. The plastic overmold formed on the cheek plate assemblies forms keyway openings 36a,b and elongated openings 38a,b that align exactly with the keyways 50 and elongated openings 52 in the metallic cheek frames to enable entry of the key 37 from either side of the handcuff for releasing the locking bar and locking pawl from double locked relation with the ratchet teeth on an associated bow 18. The laterally opposed elongated slots 52 in the base frames and aligned openings 38a,b in the plastic overmold enable insertion of the key shaft 37a to move the lock bar into its double locking position. Each of the base frames 42 also has a pair of laterally aligned generally square openings 54 for receiving a flexible detent formed on a side cover of the lockset assembly so as to releasably retain the lockset within the base frame while permitting removal of the lockset assembly by insertion of a suitable small cylindrical shaft into the recess 54 to depress the detent on the lockset and enable removal from the cheek plate frame. A significant advantage of the plastic overmold is that alignment and unimpeded access to the keyway, elongated and square openings in the cheek plate frames is assured and ready entry of keys and the like for cooperation with the lockset assembly is unobstructed.

As illustrated in FIG. 6, each of the cheek plate base frames 42 has a rectangular recess 58 formed therein sized to snugly receive a generally U-shaped hinge or pivot member 60 having laterally aligned polygonal shaped, preferably square, openings 60a and 60b formed therein. The pivot members 60 are configured so that the square openings 60a,b are disposed between and exposed outwardly of the parallel upper and lower walls of the base frame 42 within the rectangular opening or recess 58. As will be described, the square shaped openings 60a and 60b are transversely aligned and serve to receive similar size polygonal or square shaped ends of a pair of pivot shafts carried by the connecting block 16 that define the pivot or hinge axes for the handcuffs. Each of the hinge or pivot members 60 has a generally planar exposed wall surface 60c that is disposed normal to and transversely of the longitudinal axis of the corresponding handcuff when mounted on a cheek plate base frame. In this respect, the planar surfaces 60c define planar end walls for the handcuffs that lie in planes normal to the upper and lower surfaces of the handcuffs and are transverse to the longitudinal axes of the handcuffs.

Each of the plastic hinge or pivot members 60 has a generally U-shaped ridge or rim 62 formed integral with a lower marginal edge of the U-shaped hinge member, and has a generally U-shaped square ridge 62b formed on the outer surface of the hinge member spaced a predetermined distance below an upper edge surface 62c of the hinge member. The ridges 62a and 62b are spaced apart a distance that allows the hinge member to slidingly fit within the rectangular recess 58 in the base frame portion 42 of the cheek plate assembly with the arm portions 42a and 42b of the base frame snugly sliding between the ridges 62a and 62b. Prior to mounting the hinge members 60 on the stamped cheek plate frames, pivot shafts that pivotally interconnect the cheek plate frames to the connecting block 16 are-mounted on the hinge members, as will be described. With the hinge members 60 assembled within the recesses 58 of the base frames, the assembled hinge members and stamped cheek plates can be inserted into the cavity of a mold that can be closed about the cheek plate base frame and cheek plate arms, and engages the marginal edge surface 62c of the hinge member. A suitable mold piece is then inserted internally of the cheek plate assembly and a polymer is injected into the mold so as to form a polymer overmold on the inner and outer surfaces of the cheek plate assembly, with ridges 62b serving as a platform for forming outwardly inclined polymer curved surfaces that cooperate with the connecting block surface to define a raised palm swell physical indicia on the handcuff handgrip, as will be described.

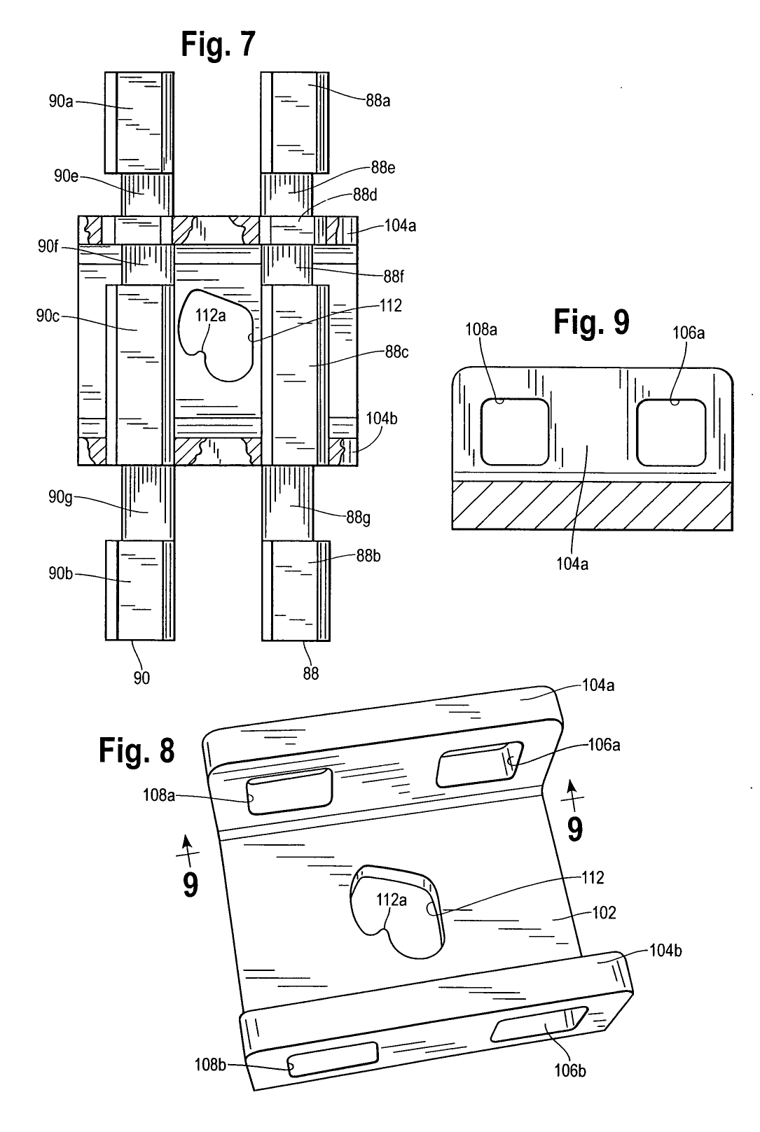

Referring again to FIG. 6 taken in conjunction with FIGS. 7-10, the connecting block 16 includes a generally rectangular housing, indicated generally at 70, that includes a base 72 and a cover 74. The base 72 and cover 74 are preferably formed of a suitably strength lightweight plastic and are adapted to be fitted together in interfacing relation by a plurality of cylindrical guide pins 76 formed on the base 72 that are received within bores or recesses in the opposing face of the cover member 74. When in assembled relation, the base 72 and cover 74 of housing 70 are preferably secured together by sonic welding, although they may be secured together by a suitably adhesive or mechanical connection. When assembled, the base and cover define pairs of aligned cylindrical openings formed by axially aligned semi-cylindrical surfaces 78a,b and 80a,b formed in the base 72 and similar sized axially aligned semi-cylindrical surfaces formed in the cover 74 as indicated at 82a and 84a in FIG. 6. The semi-cylindrical surfaces 78a,b, 80a,b, 82a and 84a may be formed as bushings to receive and support cylindrical surface portions of identical metallic pivot or hinge shafts 88 and 90.

When in assembled relation, the base 72 and cover 74 of the connecting block housing define a hollow generally rectangular internal chamber through which the pivot shafts 88 and 90 extend. A rectangular plastic block 92 is formed integral with or otherwise suitably secured to a base surface 72a of the connecting block base 72 and has a cylindrical bore 94 formed therein parallel to the base surface to receive and support a coil compression spring 96. The block 92 has an upper surface 92a that lies in a plane parallel to the base surface 72a and which serves as a stop surface to receive the end of a key, such as the end 37b of key 37 (FIG. 11), when inserted into a keyway 98 formed in the upper surface of the cover 74, as will be described.

Prior to forming the polymer overmold on the stamped cheek plate frame so as to form curved polymer marginal lateral edges on the bracelet handcuffs and substantially fill the space between the upper and lower margins of the base frame arms 42a,b and prior to mounting the pivot shafts 88 and 90 within the connecting block housing 70 between the base 72 and cover 74, the pivot shafts are first mounted within a generally U-shaped locking member 100. The locking member 100 includes a planar wall 102 and parallel sidewalls 104a and 104b that lie in planes normal to the planar wall 102. The sidewalls 104a and 104b have rectangular or polygonal openings in the form of axially aligned square openings 106a,b and 108a,b of equal size. As illustrated in FIG. 7, the pivot or hinge shafts 88 and 90 are substantially identical and each has opposite end portions 88a,b and 90a,b, respectively, of square transverse cross-section. The pivot shaft end portions are inserted into the square holes 106a,b and 108a,b formed in the locking member 100 and are then inserted into the opening openings 60a,b in the hinge or pivot members 60 after which the hinge members are mounted on to the base frames arms 42a,b of the cheek frames prior to polymer overmolding. In this manner, rotation of the hinge members and associated cheek frames about the axes of the pivot shafts also effects rotation of the pivot shafts. After so mounting the pivot shafts 88 and 90 within the rectangular openings 106a,b and 108a,b of the locking member 100, and then mounting the polygonal ends of the pivot shafts to the hinge members 60, the base 72 and cover 74 of the connecting block housing are secured together to cover the pivot shafts and locking member within the connecting block.

The pivot shafts 88 and 90 further have portions of their longitudinal lengths intermediate their opposite ends, as indicated at 88c,d and 90c,d, that are formed of substantially the same square or polygonal transverse cross-section as the ends and are adapted to be slidingly received within the rectangular aligned openings 106a,b and 108a,b in the locking member 100 so that the pivot shafts are parallel and coplanar. The intermediate rectangular cross-sectional lengths 88c,d and 90c,d on the pivot shafts are interconnected to each other and to their opposite rectangular end portions by cylindrical lengths of the pivot shafts as indicated at 88,fg and 90e,f,g. By so constructing the pivot shafts 88 and 90 and the locking member 100, it will be appreciated that with the rectangular lengths 88c,d and 90c,d disposed within the rectangular openings 106a,b and 108a,b in the locking member, the pivot shafts will be prevented from rotating about their longitudinal axes. Conversely, when the locking member 100 is moved to a position wherein the cylindrical length portions of the pivot shafts are disposed within the rectangular openings 106a,b and 108a,b in the locking member, the pivot shafts handcuffs 12 and 14 can rotate about the longitudinal axes of the pivot shafts, thereby allowing the handcuffs to be folded about their pivot axes to overlying juxtaposed positions as shown in FIG. 5.

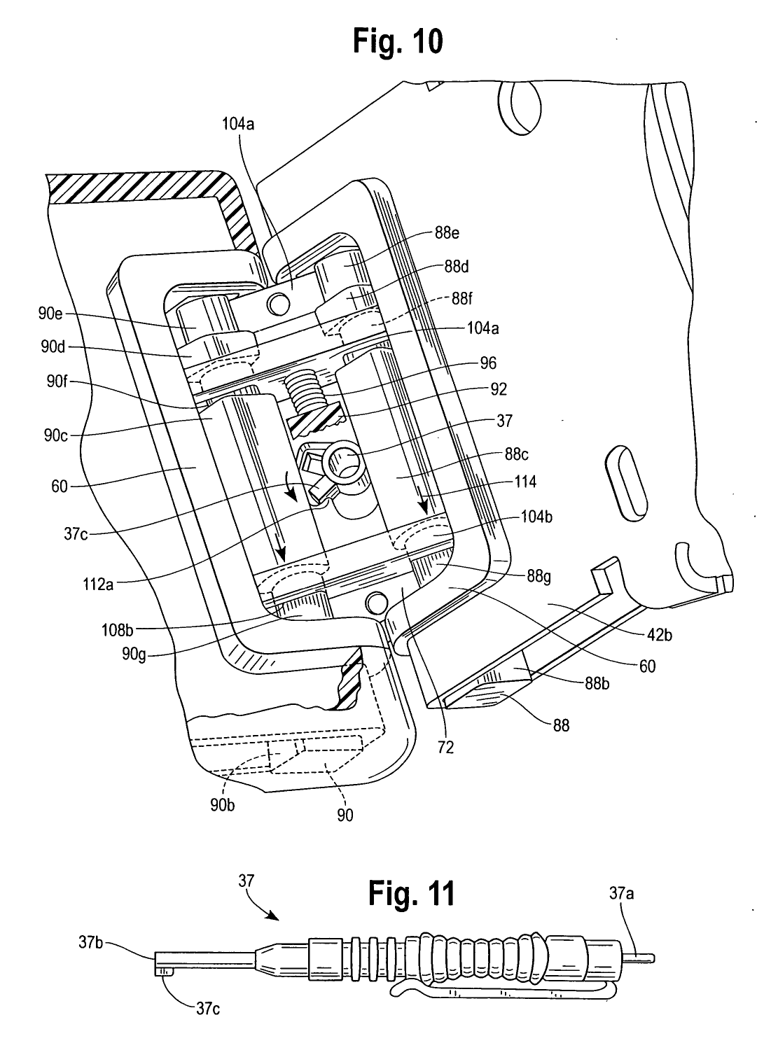

Referring again to FIG. 6 take in conjunction with FIG. 10, the coil compression spring 96 is sized so that when inserted within the blind cylindrical bore 94 in the support block 92, the free end of the spring acts against the sidewall 104a of the locking member 100 and biases the locking member toward a position wherein the sidewall 104a engages the opposing inner surface of the connecting block housing sidewall. Thus, when the handcuffs 12 and 14 are in aligned substantially coplanar relation with the connecting block, the locking member 100 will be biased to a position wherein the rectangular cross-sectional lengths 88c,d and 90c,d of the pivot shafts will automatically enter and mate with the rectangular openings 106a,b and 108a,b in the locking member, thereby locking the handcuffs in rigid aligned substantially coplanar relation. The mating locking relationship of the rectangular lengths 88c,d and 90c,d of the pivot shafts 88 and 90 with the rectangular openings in the locking member 100 establish a substantially four sided locking arrangement between the rectangular portions of the pivot shafts and the rectangular openings in the locking member, thus creating a mechanically advantaged locking arrangement. It will be appreciated that the locking member 100 cannot lock the pivot shafts, and thus the handcuffs 12 and 14, unless the handcuffs 12 and 14 are in substantially aligned coplanar with each other and the connecting block 70.

The connecting block 16 includes means for enabling selective movement of the handcuffs 12 and 14 from their open rigid aligned substantially coplanar positions, wherein rectangular lengths of the pivot shafts 88 and 90 are captured within the rectangular openings in the locking member 100, to closed folded overlying juxtaposed positions. Such means includes a cam shaped key receiving opening 112 is provided in the wall 102 of the locking member. The cam shaped opening 112 is shaped to receive the end portion 37b of the key 37 when inserted through the keyway 98 in the cover 74 of the connecting block housing 70. With the key end 37b engaging the surface 92a on the spring holder block 92, a tooth 37c on key 37 is disposed within the cam shaped opening 112 and can act against a cam surface lobe 112a. Rotation of the key in a counterclockwise direction, as considered from the underside in FIG. 10, will move the locking member 100 in the direction of arrows 114 to a position wherein cylindrical length portions 88f, 88g and 90f, 90g of the pivot shafts 88 and 90, respectively, are disposed within the rectangular openings in the locking member. This allows the pivot shafts and handcuffs to rotate about the longitudinal axes of the pivot shafts to positions wherein the handcuffs are in closed overlying juxtaposed positions. The spacing between the rectangular cross-sectional lengths 88d and 90d of the pivot shafts 88 and 90 and the rectangular cross-sectional lengths, 88c and 90c, and the thickness of the sidewalls 104a, b of the locking member 100 are selected so that a relatively minimal rotation of the key 37 inserted into the key receiving recess 112, such as 45 degrees, is sufficient to move the locking member in the direction of arrows 114 to release from the rectangular lengths 88c and 90c,d of the pivot shafts.

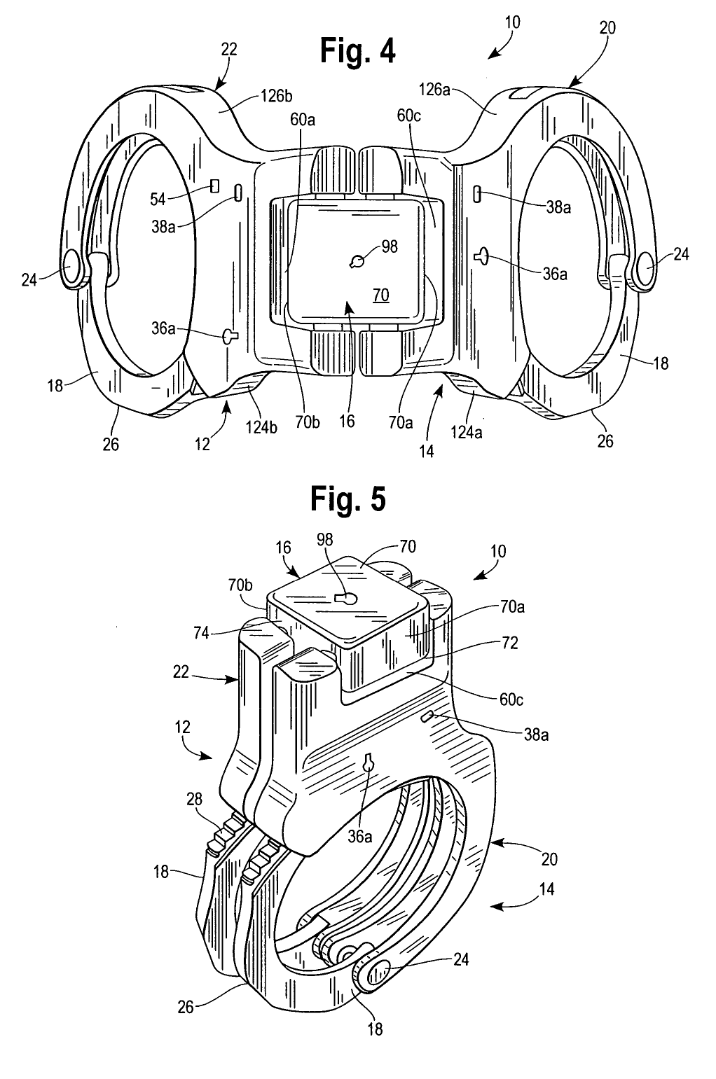

In accordance with one feature of the rigid handcuff 10, the sidewalls of the base 72 and cover 74 of the connecting block housing 70 that rotatably support pivot shafts 88 and 90 are generally planar, parallel and normal to the upper and lower surfaces of the connecting block. The other two laterally opposite the sidewalls on the connecting block housing, indicated at 70a and 70b in FIGS. 4 and 5, are juxtaposed to the planar surfaces 60c on the hinge members 60 and preferably taper slightly outwardly from their marginal comer edges to their interface plane so as to facilitate pivotal movement of the handcuffs to and from juxtaposed overlying positions to rigid aligned substantially planar positions. The lower marginal edges of the base block 72 that extend parallel to the longitudinal axes of the pivot shafts 88 and 90, such as indicated at 72a and 72b in FIG. 6, are formed with sufficient rounded curvature to allow the handcuffs to pivot downwardly relative to the connecting block when the locking member 100 is in a non-locking position with the pivot shafts. Conversely, the upper marginal edges of the cover 74 parallel to the rounded bottom marginal edges 72a,b are formed as substantially 90 degree or right angle comers so that when the locking member 100 is released from its locking relation with the pivot shafts, the right angle comers of the cover 74 juxtaposed to the planar surfaces 60c on the hinge members 60 prevent pivotal movement of the handcuffs in a pivotal direction toward the keyway 98 in the connecting block cover 74. This is particularly advantageous when an officer wishes to release the handcuffs from rigid aligned substantially coplanar positions to their folded juxtaposed positions and grasps the lower of the rigid handcuffs in his left hand with the handcuffs being generally vertical and with the keyway 98 facing the officer. In this orientation of the handcuff, the officer can grasp a key, such as key 37, with his/her right hand thumb and fingers and insert the key into the keyway 98 to release the locking member 100. By preventing pivotal movement of the upper handcuff toward the officer's hand that is manipulating the key, injury to the officer's fingers, such as may result if the uppermost handcuff were allowed to freely rotate and impact the officers fingers, is prevented.

Referring again to FIGS. 1-3, the outer surfaces of the plastic overmolded cheek plate assemblies 20 and 22 corresponding to the upper surface of the connecting block 16 having the keyway 98 formed therein are raised or inclined upwardly peripherally of the connecting block 16 so as to merge to a level substantially coplanar with the upper surface of the connecting block, as indicated at 118a and 118b in FIG. 3. The raised or upwardly inclined surface areas 118a,b of the plastic overmolded cheek plate assemblies and the upper surface of the connecting block 16 define physical indicia in the form of a palm swell on the upper surface of the rigid handcuff. The raised palm swell is adapted to be physically sensed by the palm of a user's hand gripping the handgrip portion of the handcuff with the rigid handcuff disposed in a predetermined orientation. In addition to the physical sensing indicia provided by the palm swell, the opposite surface of the rigid handcuff has physical indicia thereon adapted to be sensed by the user's thumb when grasping the handcuff with the palm swell engaging the palm of the user's hand. In the illustrated embodiment, such additional physical indicia includes a raised generally semispherical or other shape knob or projection 120 formed generally adjacent the entry area of the bow into the cheek plate assembly 20 for physical sensing by the thumb on the user's right hand when the handcuff is orientated so that the palm swell is sensed by the palm of the gripping right hand. A second physical indicia for sensing by the thumb on a user's left hand when gripping the handcuff is similarly located on the cheek plate assembly 22 but comprises a generally circular recess or depression 122 adapted to be physically sensed by the thumb on the user's left hand when gripping the handcuff with the palm swell engaging the palm of the user's left hand. Physical sensing of the palm swell by the palm of the user's hand and sensing of the physical indicia 120 or 122 by the thumb of the user's right or left hand when gripping the handcuff provide means for indicating to the user that the bows 18 of the handcuffs 12 and 14 are facing forwardly from the user's fingers and presenting the flat surface 26 on the adjacent bow for engagement with the wrist of a person on which the handcuff is to be applied. Such physical indicia on the handcuffs when in their rigid aligned positions enables one-handed manipulation of the handcuff in response to physical sensing by the palm and thumb of the user's hand without direct eye contact with the handcuff. This ability can significantly reduce the potential risk to a law enforcement officer during initial application of a handcuff to the wrist of a person being restrained. It will be understood that the provision of physical indicia in the form of a palm swell and thumb sensing indicia may also find application in rigid handcuffs that do not facilitate folding of the bracelet type handcuffs from aligned coplanar positions to overlying juxtaposed positions.

In accordance with a further feature of the rigid handcuff 10, the plastic overmold coated cheek plate assemblies 20 and 22 are contoured along their opposite marginal surfaces to shield the pointing and little finger of an officer's hand when gripping the rigid aligned handcuffs, and to also shield the web and base of the gripping hand. Referring to FIGS. 1 and 2, the handgrip defined by the rigid aligned cheek plate assemblies is contoured to establish a pair of finger shields in the form of generally concave surfaces 124a and 124b and adjacent lateral extensions 124c and 124d that receive and shield the pointing finger and little finger, respectively, of a hand gripping the handgrip of the rigid handcuff. The concave shield surfaces 124a,b prevent the user's pointing and little fingers from getting in the way of corresponding adjacent bow 18 as it rotates about its pivotal connection to the cheek plate assembly during application to a person's wrist, which could happen if the pointing finger or little finger of the gripping hand was not be shielded by the shield surfaces 124a,b. The opposite marginal edges of the plastic overmolded cheek plate assemblies 20 and 22 are contoured to define a generally concave recess surface of greater radius on each of the cheek plate assemblies, as indicated at 126a and 126b, which receive, respectively, the web and base of a user's hand when gripping the rigid handcuff. The concave recess surfaces 126a and 126b merge with extensions of the cheek plate assemblies that receive the bows 18 to also prevent the web and base of the user's hand from getting in the way of movement of the bows.

Thus, in accordance with the present invention, a rigid handcuff is provided that includes a pair of bracelet type handcuffs adapted to be secured in rigid aligned substantially coplanar open positions or pivoted about a connecting block to overlying juxtaposed closed positions for carrying on one's person. The connecting block includes locking mechanism that automatically locks the handcuffs in aligned substantially coplanar relation only when the handcuffs are disposed in open substantially coplanar relation with a plane containing the pivot axes of pivot shafts carried by the connecting block and to which the handcuffs are secured. The connecting block locking mechanism can be released to pivot the handcuffs to their juxtaposed positions through actuation of a key inserted into a keyway in the connecting block so as to move a slidable locking member in response to rotation of the key through a relatively minor rotational angle such as approximately 45°. The connecting block cooperates with the handcuffs to prevent pivotal movement of the handcuffs in the direction of the keyhole in the connecting block, thus preventing a released handcuff from impacting a person's finger when unlocking the connecting block locking mechanism. Physical indicia is formed on the handcuffs for sensing by the palm and thumb of the user's hand when gripping the rigid handcuff in a predetermined orientation, thereby allowing manipulation of the handcuff to a predetermined position for application to a person's wrist without direct eye contact with the handcuff. The lateral edges of plastic coated or orvermolded cheek plate assemblies that establish a handgrip are contoured to define shield surfaces that shield the pointing and little fingers of the user's hand gripping the rigid handcuff and also shield the web and base of the gripping hand from interfering with movement of the bows as they are applied to a person's wrists.

While a preferred embodiment of the present invention as been illustrated and described, it will be understood that changes and modifications may be made therein without departing from the invention in its broader aspects. Various features of the invention are defined in the following claims.

What is claimed is:

1. A rigid handcuff assembly comprising, in combination, a pair of bracelet type handcuffs adapted to be releasably applied to and restrain a person's wrists, said handcuffs having housings adapted for interconnection in rigid substantially coplanar aligned relation, said interconnected housings defining a handgrip when disposed in said rigid aligned relation, said handgrip having an outwardly raised surface adapted to be physically sensed by the palm of a user's hand when gripping the handgrip with the handcuff bracelets disposed in predetermined relation to the user's hand so as to enable predetermined orientation of the rigid handcuffs without direct eye contact with the handcuff assembly.

2. A rigid handcuff assembly as defined in claim 1 wherein said interconnected housings are of substantially similar size, are generally mirror imagers of each other and of a combined length sufficient to enable the user to wrap the user's figures and thumb about said handgrip with said raised surface engaging and sensed by the palm of the user's hand.

3. A rigid handcuff assembly as defined in claim 2 wherein said handcuff housings are pivotally connected to a connecting block that enables pivotal movement of said handcuffs about discrete parallel hinge axes between rigid substantially coplanar aligned positions and folded overlying juxtaposed positions.

4. A rigid handcuff assembly as defined in claim 1 wherein said housings have physical indicia thereon adapted to be sensed by a user's thumb when gripping the handcuff handgrip with the housings in said rigid aligned relation, said indicia being positioned to enable the user to determine if the handcuff assembly is in predetermined position for applying a handcuff to a subject's wrist without directing visual attention specifically to the handcuff.

5. A rigid handcuff assembly comprising a pair of bracelet type handcuffs each of which includes an arcuate bow pivotally supported on and cooperative with cheek plates of a cheek plate assembly so as to enable the bow to rotate in a predetermined direction when selectively engaged against a person's wrist, each cheek plate assembly defining a base frame containing a lock mechanism operative to releasably lock the corresponding bow in closed relation with the cheek plates, said base frames being pivotally connected to a connecting block for selective pivotal movement between first rigid aligned substantially coplanar positions and second positions in juxtaposed overlying relation to each other, said base frames and connecting block defining a handgrip having opposite side surfaces one of which is substantially planar and the other of which defines an outwardly extending raised palm swell surface adapted to be physically sensed by the palm of a person's hand when gripping the handgrip in a predetermined orientation of the handcuff assembly.

6. A rigid handcuff assembly as defined in claim 5 wherein each of said base frames includes physical sensing indicia thereon positioned to be sensed by the thumb of either the right hand or left hand of a user when the handgrip is gripped in a predetermined orientation by the user's corresponding right or left hand.

7. A rigid handcuff assembly as defined in claim 6 wherein said physical sensing indicia includes a raised pad on one of said base frames and a depression on the other base frame.

8. A rigid handcuff assembly as defined in claim 7 wherein said raised pad is formed on one of the base frames in a position to be sensed by a user's thumb when the handgrip is gripped by the user's right hand in a predetermined orientation with said raised palm surface contacting the user's palm, said depression being formed on the other of said base frames so as to be sensed by the user's left hand thumb when the handgrip is gripped by the user's left hand in a predetermined orientation with said raised palm surface contacting the palm of the user's left hand.

9. A rigid handcuff assembly as defined in claim 6 wherein said physical sensing indicia is positioned so that an external convex surface on each of the handcuff bows faces forwardly from the user's right hand or left hand fingers when gripping the handgrip in a predetermined orientation with the raised palm surface contacting the palm of the user's left or right hand, whereby said external convex bow surface facing forwardly from the user's gripping fingers can be readily engaged against a person's arm or wrist.

10. A rigid handcuff assembly as defined in claim 5 wherein said connecting block and base frames are pivotally interconnected and mutually cooperable to limit pivotal movement of the handcuffs in a predetermined common pivotal direction when moved between rigid substantially coplanar positions and overlying juxtaposed positions.

11. A rigid handcuff assembly as defined in claim 10 wherein said connecting block is generally rectangular and has parallel end surfaces each of which is disposed in juxtaposed relation to a generally planar base surface on a corresponding one of said base frames, said juxtaposed end surfaces and planar base surfaces being cooperative to enable pivotal movement of the handcuffs in said predetermined common pivotal direction and prevent pivotable movement of the handcuffs in a direction opposite to said predetermined common pivotal direction when the handcuffs are moved from rigid substantially planar relation to overlying juxtaposed relation.

12. A rigid handcuff assembly as defined in claim 11 wherein said parallel end surfaces on said connecting block are received within rectangular recesses formed in said base frame and defined in part by said generally planar base surfaces.

13. A rigid handcuff assembly as defined in claim 12 wherein said parallel end surfaces on said connecting block lie in planes generally normal to and intersecting opposite top and bottom surfaces on said connecting block so as to define marginal comers on said end surfaces, said juxtaposed planar base surfaces on said base frames lie in planes substantially normal to and intersecting top and bottom surfaces of said base frames, selected ones of said end surface marginal comers being rounded or recessed to enable pivotal movement of the handcuff housings in said predetermined common pivotal direction, the remainder of said end surface marginal comers being substantially right-angle comers adapted to prevent pivotal movement of the handcuff housings in a direction opposite to said predetermined common pivotal direction.

14. A rigid handcuff as defined in claim 10 wherein said connecting block has a first outer surface defining the raised palm surface and an opposite second outer surface substantially coplanar with adjacent outer surface of said base frames when said handcuffs are disposed in rigid aligned substantially coplanar relation, said connecting block having locking means therein for releasably retaining the handcuffs in said aligned relation, said first outer surface on said connecting block having a keyway enabling entry of a key to release said locking means so as to allow the handcuffs to pivot to overlying juxtapose positions.

15. A rigid handcuff as defined in claim 14 wherein said base frames and connecting block are cooperative to only allow pivotal movement of said base frames in a direction opposite the side of the connecting block having the keyway therein.

16. A rigid handcuff assembly as defined in claim 5 wherein said connecting block supports a pair of pivot shafts in substantially parallel coplanar relation, said pivot shafts each having similar polygonal transverse cross-sections throughout predetermined portions of their lengths with opposite ends of polygonal cross-section extending outwardly from laterally opposite sides of said connecting block, said handcuff base frames each being connected to the opposite outer polygonal ends of a pivot shaft so as to rotate therewith about the longitudinal axis of the shaft, said pivot shafts having substantially cylindrical surfaces formed in predetermined positions along their lengths intermediate said polygonal cross-sectional lengths, and a locking member disposed within the connecting block and having polygonal openings therein adapted to receive said polygonal cross-sectional lengths of said pivot shafts therethrough, said locking member being movable along said pivot shafts between a first locking position wherein said polygonal openings mate with polygonal cross-sectional portions of said pivot shafts to prevent rotation of said pivot shafts and handcuff base frames about the longitudinal axes of the pivot shafts, and a second position wherein said polygonal openings are disposed about said cylindrical surfaces on said pivot shafts to enable pivotal movement of said pivot shafts and base frames about the axes of the pivot shafts.

17. A rigid handcuff assembly as defined in claim 16 including biasing means disposed within said connecting block for biasing said locking member toward a selected one of said first and second positions.

18. A rigid handcuff assembly as defined in claim 16 wherein said locking member is generally U-shaped and defines a planar wall portion and a pair of parallel end walls having said polygonal openings formed therein.

19. A rigid handcuff assembly as defined in claim 16 wherein said polygonal openings in said locking member are sized and oriented so as to prevent mating with said polygonal cross-sectional portions of said pivot shafts unless said pivot shafts and handcuff base frames are in substantially aligned coplanar relation to said to said connecting block.

20. A rigid handcuff assembly as defined in claim 19 wherein said cylindrical surfaces on said pivot shafts are located so that said cylindrical surfaces are disposed within said polygonal openings in said locking member when said pivot shafts and handcuff base frames are not in said substantially aligned coplanar relation with said connecting block, thereby enabling said base frames to pivot about the axes of said pivot shafts relative to said connecting block.

21. A rigid handcuff assembly as defined in claim 19 including means supported by said connecting block for biasing said locking member to a position wherein said polygonal openings receive and mate with polygonal surfaces on said pivot shafts so as to prevent pivotal movement of said handcuffs about the axes of the pivot shafts when the handcuff base frames are disposed in substantially aligned coplanar relation with said connecting block.

22. A rigid handcuff assembly as defined in claim 21 wherein said biasing means comprises spring means interposed between said connecting block and said locking member.

23. A rigid handcuff assembly as defined in claim 22 wherein said locking member includes a generally planar surface disposed substantially parallel to an outer wall of said connecting block, said outer wall of said connecting block having a keyway therein aligned with a key receiving recess formed in said planar surface of said locking member, said key receiving recess being configured to receive and cooperate with a key actuator to move said locking member to its second position in response to predetermined rotation of the key actuator.

24. A rigid handcuff assembly as defined in claim 23 wherein said key receiving recess and key actuator are mutually cooperable to enable movement of said locking member from its first position to its second position in response to rotation of the key actuator through approximately 45 degrees about its longitudinal axis.

25. A rigid handcuff assembly as defined in claim 16 wherein said locking member and pivot shafts are mutually cooperable to prevent movement of said locking member from said second position to said first position until said handcuffs are in substantially aligned coplanar relation.

26. A rigid handcuff assembly as defined in claim 21 wherein said biasing means is operative to automatically move said locking member to said first position to releasably lock the handcuffs in rigid aligned substantially coplanar relation after the locking member is returned to its second position by a key actuator.

27. A rigid handcuff assembly as defined in claim 23 wherein said keyway in said connecting block is located on a side of the connector block opposite the direction in which the handcuff base frames pivot when moved from rigid aligned positions to juxtaposed overlying positions.

28. A rigid handcuff assembly as defined in claim 5 wherein said base frames and connecting block are configured to define a smooth curved handgrip surface area for comfortably receiving the base and web positions of a user's hand when the handcuffs are in rigid substantially aligned coplanar relation.

29. A rigid handcuff assembly as defined in claim 28 wherein the base frame of each handcuff has a generally concave surface curvature laterally opposite the surface area engaged by the base or web portions of the user's hand when gripping the handgrip surface area with the handcuffs in rigid aligned relation, said concave surface curvature being configured to receive the user's pointer finger and little finger and prevent them from being contacted by the handcuff bows during manipulation of the handcuff assembly.

30. A rigid handcuff assembly comprising a pair of bracelet type handcuffs each of which includes an arcuate bow pivotally supported on and cooperative with cheek plates of a cheek plate assembly so as to enable the bow to rotate in a predetermined direction when selectively engaged against a person's wrist, each cheek plate assembly defining a base frame containing a lock mechanism operative to releasably lock the corresponding bow in closed relation with the cheek plates, said base frames being pivotally connected to a connecting block for selective pivotal movement between first rigid aligned substantially coplanar positions and second positions in juxtaposed overlying relation to each other, said base frames defining a handgrip adapted to be grasp by a user's hand when disposed in said first position, said handgrip having means for enabling physical sensing by the palm of the user's hand when gripping the handgrip with the handcuffs in a predetermined orientation relative to the user's hand.

31. A rigid handcuff assembly as defined in claim 30 wherein said handgrip has additional means for enabling sensing by the thumb of a user's hand when gripping the handgrip and with the handcuff oriented so that the bows face forwardly from the user's hand.

32. A rigid handcuff assembly as defined in claim 31 wherein said means for enabling sensing by the user's thumb comprises a raised knob proximate a first end of the handgrip, and a recess proximate a second end of the handgrip opposite said first end, said raised knob and recess being formed on a side of the handgrip opposite the side on which the means for physical sensing by the palm of the user's hand is formed.

33. A rigid handcuff assembly as defined in claim 30 wherein said handgrip includes means for shielding the pointing finger and little finger of a user's hand when gripping the handgrip.

34. A rigid handcuff assembly as defined in claim 32 wherein said handgrip further includes means for shielding the web and base of the user's hand when gripping the handgrip with the thumb of the user's hand sensing the raised knob or recess.

35. A rigid handcuff assembly comprising a pair of bracelet type handcuffs each of which includes an arcuate bow pivotally supported on and cooperative with cheek plates of a cheek plate assembly so as to enable the bow to rotate in a predetermined direction when selectively engaged against a person's wrist, each cheek plate assembly defining a base frame containing a lock mechanism operative to releasably lock the corresponding bow in closed relation with the cheek plates, said base frames being pivotally connected to a connecting block through pivot shafts for selective pivotal movement between first open rigid aligned substantially coplanar positions and second closed positions in juxtaposed overlying relation to each other, said connecting block including locking means for automatically locking said frame members in said open rigid aligned substantially coplanar relation only when both said frame members are disposed in substantially coplanar relation with each other.

36. A rigid handcuff assembly comprising a pair of bracelet type handcuffs each of which includes an arcuate bow pivotally supported on and cooperative with cheek plates of a cheek plate assembly so as to enable the bow to rotate in a predetermined direction when selectively engaged against a person's wrist, each cheek plate assembly defining a base frame pivotally interconnected to a connecting block for enabling selective pivotal movement of said base frames between first rigid aligned substantially coplanar positions and second positions in juxtaposed overlying relation to each other, said connecting block having a keyway provided in an exposed surface thereof accessible by a key to facilitate movement of said base frames to second positions, said connecting block and base frames being mutually cooperable to limit pivotal movement of the handcuffs only in a pivotal direction away from said keyway surface when moved between rigid substantially coplanar positions and overlying juxtaposed positions.

37. A rigid handcuff assembly as defined in claim 36 wherein said connecting block is generally rectangular and has parallel end surfaces each of which is disposed in juxtaposed relation to a generally planar base surface on a corresponding one of said base frames, said juxtaposed end surfaces and planar base surfaces being cooperative to enable pivotal movement of the handcuffs in said predetermined common pivotal direction and prevent pivotable movement of the handcuffs in a direction opposite to said predetermined common pivotal direction when the handcuffs are moved from rigid substantially coplanar positions to overlying juxtaposed positions.

38. A rigid handcuff assembly as defined in claim 37 wherein said parallel end surfaces on said connecting block are received within rectangular recesses formed in said base frame and defined in part by said generally planar base surfaces.

39. A rigid handcuff assembly as defined in claim 38 wherein said parallel end surfaces on said connecting block lie in planes generally normal to and intersecting opposite top and bottom surfaces on said connecting block so as to define marginal comers on said end surfaces, said juxtaposed planar base surfaces on said base frames lie in planes substantially normal to and intersecting top and bottom surfaces of said base frames, selected ones of said end surface marginal comers being rounded or recessed to enable pivotal movement of the handcuff housings in said predetermined common pivotal direction, the remainder of said end surface marginal comers being substantially right-angle comers adapted to prevent pivotal movement of the handcuff housings in a direction opposite to said predetermined common pivotal direction.

40. A rigid handcuff as defined in claim 36 wherein said connecting block has a first outer surface and an opposite second outer surface generally coplanar with adjacent outer surfaces of said base frames when said handcuffs are disposed in rigid aligned substantially coplanar relation, said connecting block having a locking mechanism therein for releasably retaining the handcuffs in said aligned relation, said first outer surface on said connecting block having said keyway therein enabling entry of a key to release said locking mechanism so as to allow the handcuffs to pivot to overlying juxtapose positions.

41. A rigid handcuff as defined in claim 40 wherein said base frames and connecting block are cooperative to only allow pivotal movement of said base frames in a direction opposite the side of the connecting block having the keyway therein.

42. A rigid handcuff assembly as defined in claim 36 wherein said connecting block supports a pair of pivot shafts in substantially parallel coplanar relation, said pivot shafts each having similar polygonal transverse cross-sections throughout predetermined portions of their lengths with opposite ends of polygonal cross-section extending outwardly from laterally opposite sides of the said connecting block, said handcuff base frames each being connected to the opposite outer polygonal ends of a pivot shaft so as to rotate therewith about the longitudinal axis of the shaft, said pivot shafts having substantially cylindrical surfaces formed in predetermined positions along their lengths intermediate said polygonal cross-sectional lengths, and a locking member disposed within the connecting block and having polygonal openings therein adapted to receive said polygonal cross-sectional lengths of said pivot shafts therethrough, said locking member being movable along said pivot shafts between a first locking position wherein said polygonal openings mate with polygonal cross-sectional portions of said pivot shafts to prevent rotation of said pivot shafts and handcuff base frames about the longitudinal axes of the pivot shafts, and a second position wherein said polygonal openings are disposed about said cylindrical surfaces on said pivot shafts to enable pivotal movement of said pivot shafts and base frames about the axes of the pivot shafts.

43. A rigid handcuff assembly as defined in claim 42 including biasing means disposed within said connecting block for biasing said locking member toward a selected one of said first and second positions.

44. A rigid handcuff assembly as defined in claim 42 wherein said locking member is generally U-shaped and defines a planar wall portion and a pair of parallel end walls having said polygonal openings formed therein.

45. A rigid handcuff assembly as defined in claim 42 wherein said polygonal openings in said locking member are sized and oriented so as to prevent mating with said polygonal cross-sectional portions of said pivot shafts unless said pivot shafts and handcuff base frames are in a predetermined orientation relative to said to said connecting block.

46. A rigid handcuff assembly as defined in claim 45 wherein said cylindrical surfaces on said pivot shafts are located so that said cylindrical surfaces are disposed within said polygonal openings in said locking member when said pivot shafts and handcuff base frames are not in said predetermined orientation, thereby enabling said base frames to pivot about the axes of said pivot shafts relative to said connecting block.

47. A rigid handcuff assembly as defined in claim 45 including means supported by said connecting block for biasing said locking member to a position wherein said polygonal openings receive and mate with polygonal surfaces on said pivot shafts so as to prevent pivotal movement of said handcuffs about the axes of the pivot shafts when the handcuff base frames are disposed in substantially aligned coplanar relation with said connecting block.

48. A rigid handcuff assembly as defined in claim 47 wherein said biasing means comprises spring means interposed between said connecting block and said locking member.

49. A rigid handcuff assembly as defined in claim 48 wherein said locking member includes a generally planar surface disposed substantially parallel to an outer wall of said connecting block, said outer wall of said connecting block having a keyway therein aligned with a key receiving recess formed in said planar surface of said locking member, said key receiving recess being configured to receive and cooperate with a key actuator to move said locking member to its second position in response to predetermined rotation of the key actuator.

50. A rigid handcuff assembly as defined in claim 49 wherein said key receiving recess and key actuator are mutually cooperable to enable movement of said locking member from its first position to its second position in response to rotation of the key actuator through approximately 45 degrees about its longitudinal axis.

51. A rigid handcuff assembly as defined in claim 42 wherein said locking member and pivot shafts are mutually cooperable to prevent movement of said locking member from said second position to said first position until said handcuffs are in substantially aligned coplanar relation.

52. A rigid handcuff assembly as defined in claim 47 wherein said biasing means is operative to automatically move said locking member to said first position to releasably lock the handcuffs in rigid aligned substantially coplanar relation after the locking member is returned to its second position by a key actuator.

53. A rigid handcuff assembly as defined in claim 49 wherein said keyway in said connecting block is located on a side of the connector block opposite the direction in which the handcuff base frames pivot when moved from rigid aligned positions to juxtaposed overlying relation.

54. A rigid handcuff assembly as defined in claim 42 wherein said base frames and connecting block are configured to define a smooth curved handgrip surface area for comfortably receiving the base and web positions of a user's hand when the handcuffs are in rigid substantially aligned coplanar relation.

55. A rigid handcuff assembly as defined in claim 54 wherein the base frame of each handcuff has a generally concave surface curvature laterally opposite the surface area engaged by the base or web portions of the user's hand when gripping the handgrip surface area with the handcuffs in rigid aligned relation, said concave surface curvatures being configured to receive the user's pointer finger and little finger and prevent them from being contacted by the handcuff bows during manipulation of the handcuff assembly.

56. A rigid handcuff assembly comprising a pair of bracelet type handcuffs each of which includes an arcuate bow pivotally supported on and cooperative with cheek plates of a cheek plate assembly so as to enable the bow to be applied about a person's wrist, each cheek plate assembly defining a base frame pivotally interconnected to a connecting block for pivotal movement of said base frames between first rigid aligned substantially coplanar positions and second positions in juxtaposed overlying relation to each other, said connecting block supporting a pair of pivot shafts in substantially parallel coplanar relation, said pivot shafts each having similar polygonal transverse cross-sections throughout predetermined portions of their lengths with opposite ends of polygonal cross-section extending outwardly from laterally opposite sides of the said connecting block, said base frames each being connected to the opposite outer polygonal ends of a pivot shaft so as to rotate therewith about the longitudinal axis of the shaft, said pivot shafts having substantially cylindrical surfaces formed in predetermined positions along their lengths intermediate said polygonal cross-sectional lengths, and a locking member disposed within the connecting block and having polygonal openings therein adapted to receive said polygonal cross-sectional lengths of said pivot shafts therethrough, said locking member being movable along said pivot shafts between a first locking position wherein said polygonal openings mate with polygonal cross-sectional portions of said pivot shafts to prevent rotation of said pivot shafts and handcuff base frames about the longitudinal axes of the pivot shafts, and a second position wherein said polygonal openings are disposed about said cylindrical surfaces on said pivot shafts to enable pivotal movement of said pivot shafts and base frames about the axes of the pivot shafts.

57. A rigid handcuff assembly comprising a pair of handcuff bracelets adapted to be releasably applied to and restrain a subjects wrists, said handcuffs having housings disposed in rigid substantially coplanar aligned relation, said interconnected housings defining a handgrip having physical indicia thereon positioned to be physically sensed by the thumb of a user's hand when gripping the handgrip with the handcuff bracelets disposed in predetermined relation to the user's hand so as to enable predetermined orientation of the rigid handcuffs without direct eye contact with the handcuff assembly.

58. A rigid handcuff assembly as defined in claim 57 wherein the handgrip includes physical sensing indicia thereon positioned to be sensed by the thumb of either the right hand or left hand of a user when the handgrip is gripped in a predetermined orientation by the user's corresponding right or left hand.

59. A rigid handcuff assembly as defined in claim 58 wherein said physical sensing indicia includes a raised pad on one of said interconnected housings and a depression on the other of said housings.

60. A rigid handcuff assembly as defined in claim 59 wherein said handgrip has a raised palm swell thereon adapted to be physically sensed by a user's palm when gripping the handgrip in a predetermined orientation, said raised pad being disposed in a position to be sensed by a user's thumb when the handgrip is gripped by the user's right hand in a predetermined orientation with said raised palm swell contacting the user's palm, said depression being formed on the other of said base frames so as to be sensed by the user's left hand thumb when the handgrip is gripped by the user's left hand in a predetermined orientation with said raised palm swell contacting the palm of the user's left hand.

61. A rigid handcuff assembly as defined in claim 58 wherein each of said handcuffs include a bow adapted to be placed about a person's wrist, said physical sensing indicia being positioned so that an external convex surface on each of the handcuff bows faces forwardly from the user's right hand or left hand fingers when gripping the handgrip in an orientation such that the user's thumb senses physical indicia, whereby said external convex bow surface facing forwardly from the user's gripping fingers can be readily engaged against a person's arm or wrist.

62. A rigid handcuff assembly comprising a pair of bracelet type handcuffs each of which includes an arcuate bow pivotally supported on and cooperative with cheek plates of a cheek plate assembly so as to enable the bow to rotate in a predetermined direction when selectively engaged against a person's wrist, each cheek plate assembly defining a base frame containing a lock mechanism operative to releasably lock the corresponding bow in closed relation with the cheek plates, said base frames being pivotally connected to a connecting block for selective pivotal movement between first rigid aligned substantially coplanar positions and second positions in juxtaposed overlying relation to each other, said connecting block having a keyway formed therein enabling release of a locking mechanism within the connecting block, said connecting block and base frames being mutually cooperable to limit pivotal movement of the handcuffs only in a pivotal direction away from the keyway when moved between rigid substantially coplanar positions and overlying juxtaposed positions.

63. A rigid handcuff assembly as defined in claim 62 wherein said connecting block is generally rectangular and has parallel end surfaces each of which is disposed in juxtaposed relation to a generally planar base surface on one of said base frames, said juxtaposed end surfaces and planar base surfaces being cooperative to enable pivotal movement of the handcuffs in said predetermined common pivotal direction and prevent pivotable movement of the handcuffs in a direction opposite to said predetermined common pivotal direction when the handcuffs are moved from rigid substantially planar relation to overlying juxtaposed relation.

64. A rigid handcuff assembly as defined in claim 63 wherein said parallel end surfaces on said connecting block are received within rectangular recesses formed in said base frame and defined in part by said generally planar base surfaces.

65. A rigid handcuff assembly as defined in claim 63 wherein said parallel end surfaces on said connecting block lie in planes generally normal to and intersecting opposite top and bottom surfaces on said connecting block so as to define marginal comers on said end surfaces, said juxtaposed planar base surfaces on said base frames lie in planes substantially normal to and intersecting top and bottom surfaces of said base frames, selected ones of said end surface marginal comers being rounded or recessed to enable pivotal movement of the handcuff housings in said predetermined common pivotal direction, the remainder of said end surface marginal comers being substantially right-angle comers adapted to prevent pivotal movement of the handcuff housings in a direction opposite to said predetermined common pivotal direction.

66. A rigid handcuff as defined in claim 62 wherein said connecting block has locking means therein for releasably retaining the handcuffs in said aligned relation, said connecting block having a keyway formed in a side thereof enabling entry of a key to release said locking means so as to allow the handcuffs to pivot to overlying juxtapose positions.

67. A rigid handcuff as defined in claim 67 wherein said base frames and connecting block are cooperative to only allow pivotal movement of said base frames in a direction opposite the side of the connecting block having the keyway therein.

68. A rigid handcuff assembly comprising a pair of bracelet type handcuffs each of which includes an arcuate bow pivotally supported on and cooperative with cheek plates of a cheek plate assembly so as to enable the bow to rotate in a predetermined direction when selectively engaged against a person's wrist, each cheek plate assembly defining a base frame containing a lock mechanism operative to releasably lock the corresponding bow in closed relation with the cheek plates, said base frames being pivotally connected to a connecting block for selective pivotal movement between first positions in juxtaposed overlying relation to each other and second rigid aligned substantially coplanar positions, said connecting block supporting a pair of pivot shafts connected to said base frames in a manner to enable selective movement of said base frames between said first and second positions, and a locking member disposed within the connecting block and being slidingly cooperable with said pivot shafts when said locking member is disposed in a first position to enable movement of said base frames to said first juxtaposed positions, said locking member being movable to a second position cooperating with said pivot shafts to releasably lock said base frames in said second positions only after said base frames are fully moved to said second positions.

69. A rigid handcuff assembly as defined in claim 68 including biasing means disposed within said connecting block for biasing said locking member toward a position cooperating with said pivot shafts so as to automatically lock said frame members in aligned positions.

70. A rigid handcuff assembly as defined in claim 68 wherein said locking member is generally U-shaped and defines a planar wall portion and a pair of parallel end walls having said polygonal openings formed therein for mating cooperation with polygonal cross-sectional lengths on said pivot shafts.

71. A rigid handcuff assembly as defined in claim 70 wherein said polygonal openings in said locking member are sized and oriented so as to prevent mating with said polygonal cross-sectional portions of said pivot shafts unless said pivot shafts and handcuff base frames are in a predetermined orientation relative to said to said connecting block.

72. A rigid handcuff assembly as defined in claim 70 wherein said pivot shafts have cylindrical surfaces located so that said cylindrical surfaces are disposed within said polygonal openings in said locking member when said pivot shafts and handcuff base frames are not in said second aligned positions, thereby enabling said base frames to pivot about the axes of said pivot shafts relative to said connecting block.

73. A rigid handcuff assembly as defined in claim 70 including means supported by said connecting block for biasing said locking member to a position wherein said polygonal openings receive and mate with polygonal surfaces on said pivot shafts so as to prevent pivotal movement of said handcuffs about the axes of the pivot shafts when the handcuff base frames are disposed in substantially aligned coplanar relation relative to said connecting block.

74. A rigid handcuff assembly as defined in claim 73 wherein said biasing means comprises spring means interposed between said connecting block and said locking member.

75. A rigid handcuff assembly as defined in claim 74 wherein said locking member includes a generally planar surface disposed substantially parallel to an outer wall of said connecting block, said outer wall of said connecting block having a keyway therein aligned with a key receiving recess formed in said planar surface of said locking member, said key receiving recess being configured to receive and cooperate with a key actuator to move said locking member to its first position in response to predetermined rotation of the key actuator.

76. A rigid handcuff assembly as defined in claim 75 wherein said key receiving recess and key actuator are mutually cooperable to enable movement of said locking member from its second position to its first position in response to rotation of the key actuator through approximately 45 degrees about its longitudinal axis.

77. A rigid handcuff assembly comprising a pair of bracelet type handcuffs each of which includes an arcuate bow pivotally supported on and cooperative a cheek plate assembly so as to enable the bow to rotate in a predetermined direction when selectively engaged against a person's wrist, each cheek plate assembly defining a base frame containing a lock mechanism operative to releasably lock the corresponding bow in closed relation with the cheek plates, said base frames being pivotally connected to a connecting block for selective pivotal movement between first rigid aligned substantially coplanar positions and second positions in juxtaposed overlying relation to each other, said base frames and connecting block defining a smooth curved handgrip surface area for comfortably receiving the base and web positions of a user's hand when the handcuffs are in rigid substantially aligned coplanar relation, said handgrip surface including a generally concave surface curvature laterally opposite the surface area engaged by the base and web portions of the user's hand, said concave surface curvature being configured to receive the user's pointer finger and little finger so as to prevent them from getting in the way of the handcuff bows during manipulation of the handcuff assembly.

78. A rigid handcuff assembly as defined in claim 77 wherein said handgrip is further configured to shield the web and base of the user's hand from the bows when gripping the handgrip during manipulation of the handcuff.

79. A rigid handcuff comprising a pair of bracelet type handcuffs that are generally mirror images of each other and each of which includes an arcuate bow pivotally supported on cheek plates of a cheek plate assembly so as to enable the bow to rotate in a predetermined direction when selectively placed against a person's wrist, each cheek plate assembly defining a base frame containing a lock mechanism operative to releasably lock the corresponding bow in closed relation with the cheek plates, said base frames each having at least one keyway shaped opening formed therein for enabling entry of a key into the lock mechanism contained therein for releasing the lock mechanism from locking relation with the corresponding bow, said base frames being connected to a connecting block so that the base frames are pivotal about parallel coplanar pivot axes between positions wherein the handcuffs are releasably retained in substantially coplanar aligned relation and positions wherein the handcuffs are in overlying juxtaposed relation, and a polymer overmold formed on the cheek plate assemblies to provide a comfortable handgrip when the handcuffs are disposed in substantially coplanar aligned positions, said overmold having profiled keyway shaped openings formed therein directly aligned with the key receiving openings in the base frames and shaped to require a predetermined orientation of a key to facilitate ease of entry of keys into the keyway shaped openings in the base frames.

80. A rigid handcuff as defined in claim 79 wherein each base frame has a pair of key receiving openings formed therein on opposite sides of the base frames so that the key receiving openings are laterally spaced when considered with the handcuff in an upstanding position, said overmold defining precise keyway shaped openings directly aligned with the key receiving openings in the base frame.

81. A rigid handcuff as defined in claim 79 wherein each cheek plate assembly includes a die stamped metallic cheek plate frame having a polymer overmold formed thereon by selectively placing the cheek plate frame into a mold and injecting a polymer into the mold, and allowing the polymer overmold to solidify.

82. The rigid handcuff as defined in claim 81 wherein the polymer overmold comprises a thermoplastic.

83. A rigid handcuff as defined in claim 79 wherein the connecting block includes a plastic housing having an interior chamber, a pair of pivot shafts supported by the connecting block in parallel coplanar relation, said base frames each being connected to a discrete one of said pivot shafts for pivotal movement about a horizontal axis of the corresponding pivot shaft, said connecting block having a pair of opposite outer side surfaces one of which is substantially coplanar with a first outer surface of the handgrip when the handcuffs are disposed in generally coplanar aligned positions, the other connecting block side surface lying in a plane generally parallel to and spaced outwardly from a second outer surface of the handgrip opposite said first outer surface so that said other connecting block side surface defines a palm swell physically detectable by the palm of a user's hand when gripping the handgrip with the rigid handcuff in a predetermined orientation.

84. A rigid handcuff as defined in claim 83 wherein said first outer surface of the handgrip includes physical indicia positioned to be physically sensed by a thumb of the user when gripping the handgrip by either the left or right hand with the rigid handcuff in a predetermined orientation.

85. A rigid handcuff as defined in claim 84 wherein the physical indicia on said first outer surface of the handgrip includes a raised knob-like surface adjacent a selected end of the first outer surface physically detectable by a thumb of the user's hand when gripping the handgrip in a first predetermined orientation of the handgrip, and a depression adjacent an opposite end of the first outer surface physically detectable by the thumb of the other hand of the user when gripping the handgrip in a second predetermined orientation of the handgrip.

86. A rigid handcuff as defined in claim 83 wherein the connecting block and base frames cooperate to limit pivotal movement of the handcuffs about their respective axes in a predetermined pivotal direction when pivoting the handcuffs from aligned positions to folded overlying juxtaposed positions.

87. A method of making a rigid handcuff comprising the steps of:
forming a pair of bracelet type handcuffs that are generally mirror images of each other and each of which includes an arcuate bow pivotally supported on cheek plates of a cheek plate assembly so as to enable the bow to rotate in a predetermined direction when selectively engaged against a person's wrist, each cheek plate assembly including a die stamped metallic cheek plate frame defining a base frame adapted to receive a lock mechanism operative to releasably lock the corresponding bow in closed relation with the cheek plates, forming openings in said base frames to enable entry of a key into the lock mechanisms to release the lock mechanisms from locking relation with the bows, connecting the base frames to a connecting block so that the base frames are pivotal about parallel coplanar pivot axes between positions wherein the handcuffs are in substantially coplanar aligned relation, and positions wherein the handcuffs are in overlying juxtaposed relation, forming a lock mechanism in the connecting block operative to automatically releasably lock the handcuffs in said coplanar aligned positions when moved thereto from non-aligned positions, and
forming a polymer overmold on the cheek plate frames to provide a comfortable handgrip when the handcuffs are disposed in substantially coplanar aligned positions, and forming keyway-shaped openings in said overmold formed therein directly aligned with the key receiving openings in the base frame so as to facilitate entry of keys into the key receiving openings.

88. The method as defined in claim 87 wherein the step of forming a polymer overmold on the cheek plate frames includes the steps of selectively positioning each cheek plate frame into a mold, injecting a liquid polymer into the mold, and allowing the polymer overmold to solidify.

89. The method as defined in claim 88 wherein the polymer overmold comprises a thermoplastic.

90. The method as defined in claim 87 including the steps of forming the connecting block as a plastic housing having an interior chamber, and supporting a pair of parallel coplanar pivot shafts in said chamber, connecting each of said base frames to a discrete one of said pivot shafts for pivotal movement about a horizontal axis of the corresponding pivot shaft, said connecting block having a pair of opposite outer side surfaces one of which is substantially coplanar with a first outer surface of the handgrip when the handcuffs are disposed in generally coplanar aligned positions, the other connecting block side surface lying in a plane generally parallel to and spaced outwardly from a second outer surface of the handgrip opposite said first outer surface so that said other connecting block side surface defines a palm swell physically detectable by the palm of a user's hand when gripping the handgrip with the rigid handcuff in a predetermined orientation.

91. The method as defined in claim 90 including the step of forming physical indicia on said first outer surface of the handgrip in positions to be physically sensed by a thumb of the user when gripping the handgrip by either the left or right hand with the rigid handcuff in a predetermined orientation.

92. The method as defined in claim 91 wherein said step of forming physical indicia on said first outer surface of the handgrip includes forming a raised knob-like surface adjacent a selected end of the first outer surface physically detectable by a thumb of the user's hand when gripping the handgrip in a first predetermined orientation of the handgrip, and forming a depression adjacent an opposite end of the first outer surface physically detectable by the thumb of the other hand of the user when gripping the handgrip in a second predetermined orientation of the handgrip.

93. The method as defined in claim 90 including the step of forming the connecting block and base frames so as to limit pivotal movement of the handcuffs about their respective axes in a predetermined pivotal direction only.
